(19) United States
(12) Patent Application Publication
(10) Pub. No.: US 2016/0186387 A1
(43) Pub. Date: Jun. 30, 2016

(54) SYNTHETIC TURF ATHLETIC FIELD MAINTENANCE, RECYCLING, RECLAMATION AND RESTORATION METHOD USING GNSS-BASED EQUIPMENT GUIDANCE

(71) Applicant: MDH Turf, LLC, Shawnee, KS (US)

(72) Inventors: Patrick D. McAnany, Lake Quivira, KS (US); Edwin L. Huggins, Olathe, KS (US)

(73) Assignee: MDH Turf, LLC, Shawnee, KS (US)

(21) Appl. No.: 14/980,465

(22) Filed: Dec. 28, 2015

Related U.S. Application Data
(63) Continuation-in-part of application No. 13/863,277, filed on Apr. 15, 2013, now abandoned.
(60) Provisional application No. 61/623,686, filed on Apr. 13, 2012.

(51) Int. Cl. E01C 13/08; B29B 17/02; B29B 9/12

(52) U.S. Cl. CPC E01C 13/08; B29B 9/12; B29B 17/02; B29L 2030/00

(57) ABSTRACT

A system and method for recycling and repurposing a synthetic turf field cover including a pre-existing mixture of rubber and sand particles embedded in the turf material. The system utilizes an aspirating machine for removing and separating the existing rubber and sand particles. The removed rubber particles are reused, and can be cleaned and sterilized prior to reinstallation. A method of recycling a synthetic turf field cover includes the steps of removing the existing synthetic turf field cover, aspirating pre-existing rubber and sand particles, cleaning the rubber particles, reapplying the sterilized, reused rubber particles and applying additional rubber particles and sand to a replaced or reinstalled field turf cover.

### CROSS-REFERENCE TO RELATED APPLICATIONS

This application is a continuation-in-part of and claims priority in U.S. patent application Ser. No. 13/863,277, filed Apr. 15, 2013, which is based on and claims priority in U.S. Provisional Patent Application Ser. No. 61/623,686, filed Apr. 13, 2012, both of which are incorporated herein by reference.

### BACKGROUND OF THE INVENTION

1. Field of the Invention

The present invention relates generally to a method for maintaining artificial turf surfaces, such as athletic playing fields. More specifically, the present invention relates to a method for reclaiming, restoring and reusing synthetic turf and infill material. Still further, the present invention can save cost, time and resources by recycling synthetic turf and infill materials, such as a mixture of sand and ground rubber from tires.

2. Description of the Related Art

Artificial or synthetic turf, such as AstroTurf®, is a surface material manufactured from synthetic fibers to look like natural grass. This surface is often used in wide, flat spaces such as sporting arenas, baseball diamonds, or practice fields. Because it does not require the maintenance of natural grass, such as watering and trimming, this surface has also found growing interest in the commercial landscaping market for homes and businesses.

In some installations artificial turf is preferred over natural grass. For instance, in sports domes there is often not enough sunlight for natural grass to grow, so artificial turf is used. Artificial turf may also be preferred over ordinary grass in wet locations because it will not turn to mud after a rainfall.

Artificial turf is constructed from multiple layers. The bottom-most layer is soil. Drainage improvements may be placed in this soil. A padded layer may be placed atop the earth, followed by a water containment membrane and the artificial turf fibers. The artificial turf fibers are often filled in with infill, comprising a mixture of ground rubber pellets and sand (or sometimes silicon). The rubber-sand ratio can vary, depending on the desired resiliency of the synthetic turf field. For example, more sand generally makes the field harder and faster. Conversely, more rubber increases its resiliency, which can cushion players from field impact.

A disadvantage of typical artificial turf is that, during replacement of the turf, the rubber pellets must be discarded along with the sand mixture. The rubber particles can be recycled from vehicle tires, which promotes recycling and protects the environment by eliminating disposal issues associated with used tires. However, vehicle tire rubber particles can be difficult to dispose of properly, and may themselves pose environmental risks. What is desired is a system or method of reclaiming and reusing the rubber pellets during the reinstallation of a worn-out artificial field or landscaping installation. Heretofore there has not been available a system or method of synthetic turf recycling and reclamation with the advantages and features of the present invention.

### BRIEF SUMMARY OF THE INVENTION

The present invention relates to a system and method for reclaiming the rubber in-fill typically used in conjunction with artificial turf. The rubber pellets are typically mixed with sand, and therefore must be discarded when the artificial turf is being replaced. An aspect of the present invention uses an aspirator, such as that manufactured by Kice Industries, Inc. of Wichita, Kans., to remove the sand from the rubber pellets. The rubber may also be treated during this process to remove debris. The rubber may then be reused during the reinstallation of the turf.

### BRIEF DESCRIPTION OF THE DRAWINGS

The drawings constitute a part of this specification and include exemplary embodiments of the present invention illustrating various objects and features thereof.

FIG. 1 is a sectional view of a portion of artificial turf, showing the interaction of the various layers.

FIG. 2 is flow chart representing the various steps required to practice an embodiment of the present invention.

FIG. 3 includes a diagram embodying an aspirator machine which may be used to practice an embodiment of the present invention.

FIG. 4 is a flowchart showing a synthetic turf maintenance and restoration method embodying an alternative aspect of the present invention.

### DETAILED DESCRIPTION OF THE PREFERRED EMBODIMENTS

### I. Introduction and Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. System and Method 2 of Artificial Turf 4 Reclamation and Recycling

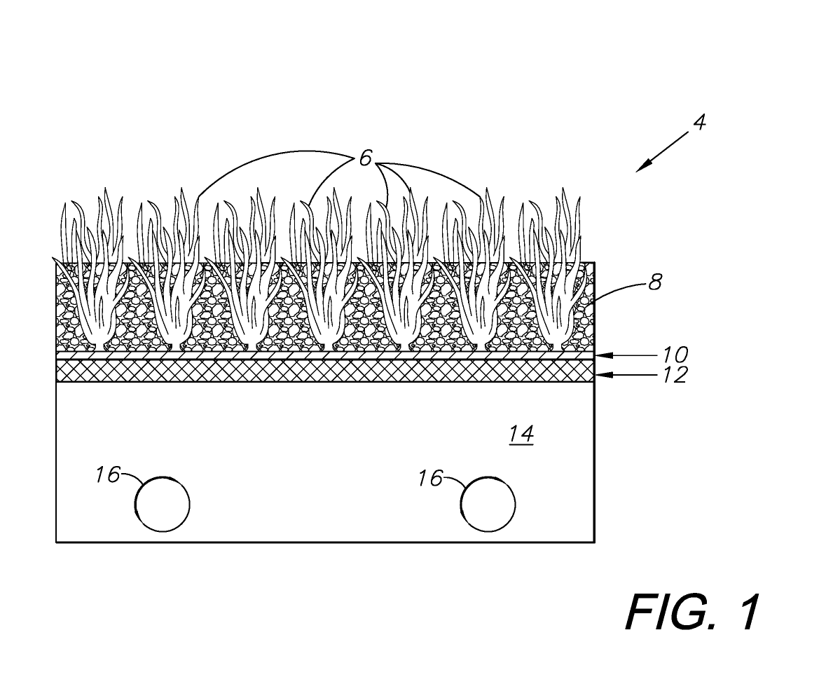

As shown in more detail in FIG. 1, artificial turf 4 is typically comprised of multiple layers. These layers include the synthetic fibers 6 designed to look and feel like natural grass, the rubber and sand in-fill 8 which is poured in between the fibers 6 to produce a softer, more natural feeling surface, a containment membrane 10 for retaining and/or removing moisture, and a base surface 14 upon which the turf 4 is placed, typically leveled earth. The base surface may include drainage piping 16 for improved water management. A shock-absorbent layer 12 to increase the padding and reduce injuries caused by falls on the turf 4 may also be placed between the membrane 10 and the base surface 14.

When replacing the artificial turf 4, the fibers 6 are typically replaced in their entirety. To do this, the sand and rubber mixture 8 is often disposed along with the turf fibers. This mixture typically comprises small rubber pellets blended with standard sand. The rubber is usually in suitable condition for additional use; however the fibers or other components of the turf 4 have worn out. Previously there has been no way to reclaim these rubber pellets.

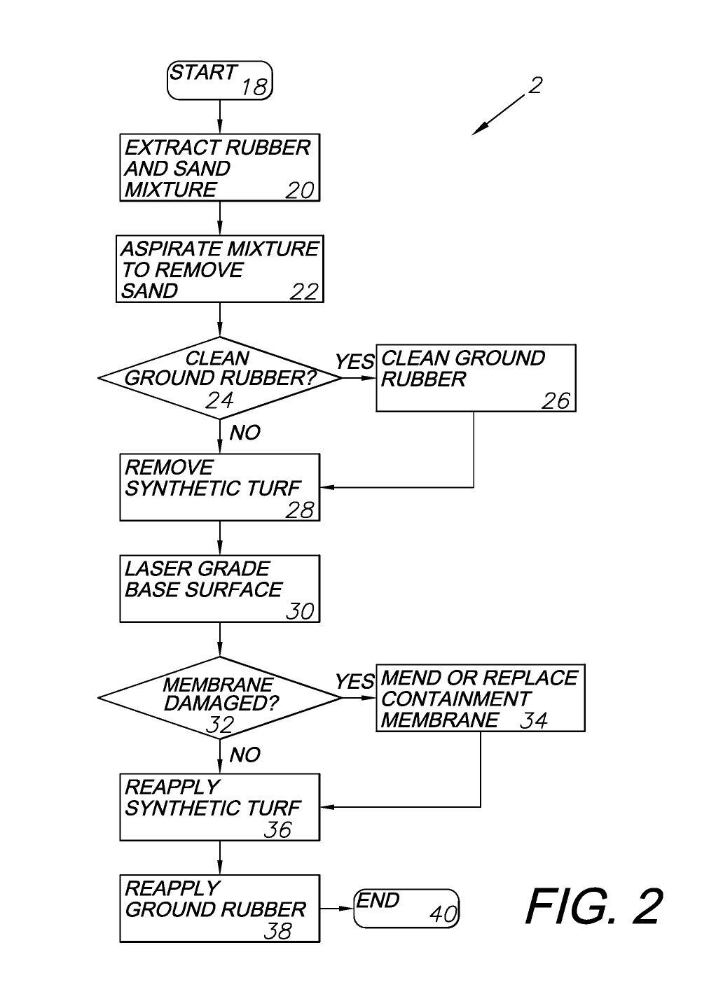

FIG. 2 demonstrates an embodiment of a method 2 for reclaiming the rubber pellets from the sand, and reusing those pellets in a reinstallation of artificial turf on a field or for landscaping. This process saves the consumer money because new rubber does not have to be purchased, and it reduces waste as the rubber does not wind up in a landfill.

The process starts 18 by identifying an artificial turf in need of replacement. The first step at 20 requires the extraction of the rubber and sand mixture 8 from the synthetic fibers 6. At 22, an aspirator machine 42, such as that produced by Kice Industries, Inc. of Wichita, Kans., may then be used to separate the rubber from the sand. The sand is removed and set aside.

Often the rubber requires cleaning to remove pathogens that are not removed via natural means, or the rubber requires cleaning for other reasons. At 24, an inquiry is made as to the need to clean the rubber pellets. If yes, the rubber is cleaned at 26. Otherwise, the step is skipped and the synthetic turf is removed at 28. The containment membrane 10 is also removed at this step.

Next, the base surface 14 is laser graded or otherwise resurfaced at 30. This will re-level the surface and insure optimum placement of the new artificial turf.

Once the surface is ready, an inquiry is made as to the suitability of the previous containment membrane 10 at 32. If the membrane is damaged or worn, it can be mended or replaced at 34. If it is still suitable for use, it may be replaced on the base surface 14 and prepped for new artificial fibers 6.

At 36, the new artificial turf is applied. This includes laying and adhering the new fibers 6 to the membrane 10. Finally, the ground rubber pellets are reapplied to the artificial turf at 38. If desired, sand can be re-mixed with the rubber pellets prior to the mixture being reapplied. The process then ends at 40, and a new artificial turf is in place of the old turf, and the rubber has been completely reclaimed and recycled.

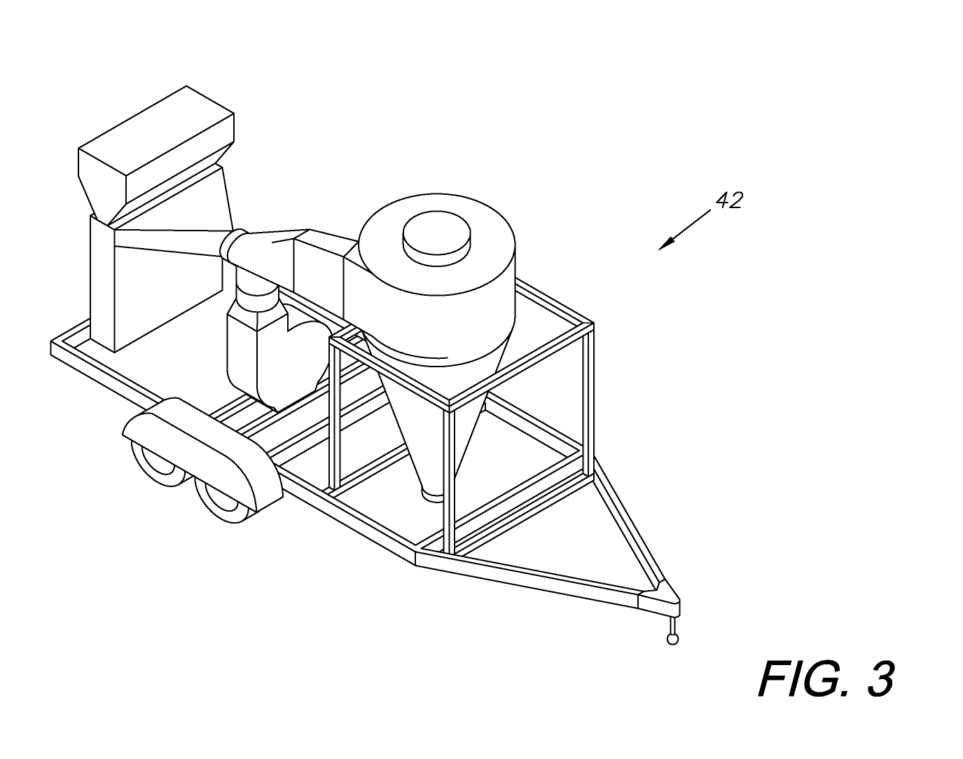

As shown in FIG. 3, an aspirator machine 42 can be used to separate the sand from the rubber. These aspirators have long been used to utilize air in order to classify materials by size and density. By placing the reclaimed sand and rubber mixture into the aspirator 42, the sand is physically blown from the rubber pellets and the two components are stored separately.

The aspirator used in the preferred embodiment of the process disclosed herein is ideally portable. As shown in FIG. 3, the aspirator should be mounted on a trailer or other mobile device for use at or near the site of the reinstallation of artificial turf.

### Alternative Synthetic Turf Maintenance Method 102

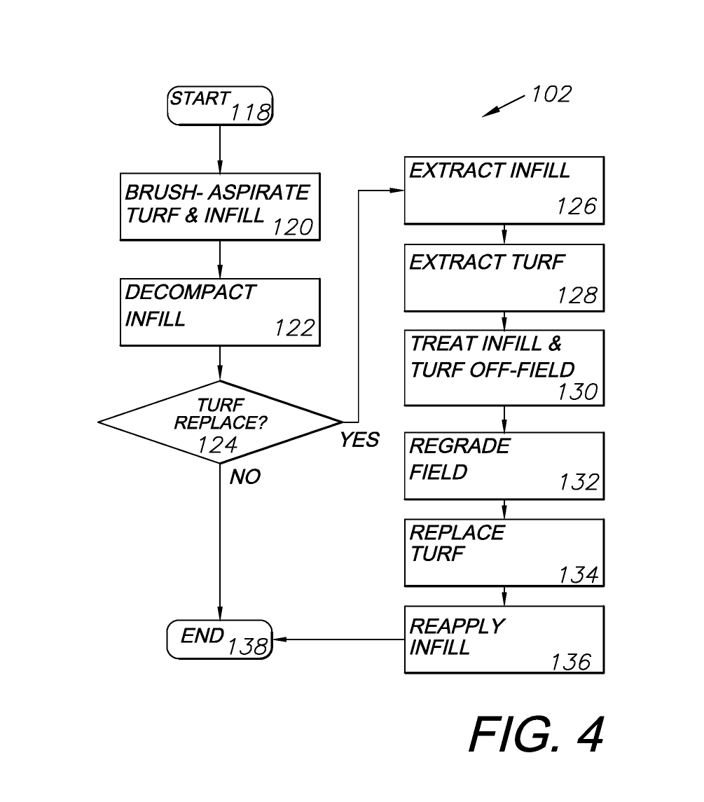

The alternative aspect or method 102 begins at start 118 (FIG. 4) and proceeds to a brush (aerate) turf and infill step 120. The infill is de-compacted at 122, for example, by the equipment brushing action and/or through aeration and forced air circulation. At decision box 124 the method branches to either an extract infill step 126 (YES decision) or ends 138 if the decision is negative (NO decision).

After extracting the infill at 126, the turf is extracted at 128 the infill and turf can be treated, e.g., off-field, at 130. The field is then regraded at 132. The regrading step eliminates uneven areas and can be guided by Global Navigation Satellite System (GNSS) positioning and machine control equipment. For example, the Global Positioning System (GPS) refers to the navigational satellite constellation operated and maintained by the United States Air Force. The turf is then replaced at 134 and infill is reapplied at 136 to end the method at 138.

It is to be understood that the invention can be embodied in various forms, and is not to be limited to the examples discussed above. The range of components and configurations which can be utilized in the practice of the present invention is virtually unlimited.

Having thus described the invention, what is claimed as new and desired to be secured by Letters Patent is:

1. A method of maintaining, reclaiming and renovating a synthetic turf athletic field including a crushed rock base material layer placed on grade; a shock-absorbing resilient material layer placed over the base material layer, a synthetic turf layer including a membrane mounting synthetic grass-like fibers protruding upwardly and infill placed in the synthetic fibers and comprising a mixture of ground rubber particles and sand, which method comprises the steps of:
rotary brushing said synthetic turf layer at first-duration periodic intervals to a first, limited-penetration depth;
extracting debris from said synthetic turf layer;
decompacting said infill;
rotary brushing said synthetic turf layer and extracting said infill material at second-duration periodic intervals to a second, deep-penetration depth corresponding to a thickness of said synthetic turf layer;
placing said extracted infill material at an off-field location;
removing said synthetic turf material layer;
mapping said base material layer surface with Global Navigation Satellite System (GNSS) location coordinates in three dimensions corresponding to X (longitude), Y (latitude) and Z (elevation) coordinates;
regrading said base material layer to a design configuration using laser-guided grading equipment;
evaluating said turf material layer condition;
treating said synthetic turf material layer if in reusable condition;
replacing said turf material layer if damaged beyond repair;
reinstalling one of said existing turf material layer or a replacement;
treating said infill material;
calibrating a ratio of rubber particles to sand in said infill material;
replacing said infill material in said synthetic turf material layer; and
evaluating a resilience and impact resistant performance characteristic of said athletic field.

2. The method according to claim 1, which includes additional steps of:
aspirating said turf material layer and said infill.

3. The method according to claim 2, which includes additional steps of:
washing said turf material layer.

4. The method according to claim 1, which includes the additional steps of:
aspirating, cleaning and supplementing said infill with additional rubber particles.

5. The method according to claim 1, which includes the additional steps of:
forming said rubber particles from recycled vehicle tires.

6. The method according to claim 1, which includes the additional steps of:
aspirating said infill material with a cyclone separator.

7. The method of claim 1, which includes the additional step of:
providing said synthetic turf layer with a predetermined percentage of rubber and sand particles.

8. The method of claim 1, which includes the additional step of:
extracting an existing rubber and sand particle mixture from an existing synthetic turf field cover.

9. The method of claim 8, which includes the additional step of:
aspirating the rubber-sand mixture to remove sand therefrom.

10. The method of claim 9, which includes the additional step of:
cleaning the extracted rubber.
